(19) United States
(12) Patent Application Publication
(10) Pub. No.: US 2026/0280914 A1
(43) Pub. Date: Sep. 17, 2026

(54) COMMUNICATION SYSTEM, ELECTRONIC CONTROL UNIT, WAKE-UP RETENTION PROGRAM STORED ON NON-TRANSITORY STORAGE MEDIUM, AND WAKE-UP RETENTION METHOD

(71) Applicant: DENSO CORPORATION, Kariya-city (JP)

(72) Inventors: Yukihiro YAMAKAWA, Kariya-city (JP); Tomoya TOKUNAGA, Kariya-city (JP)

(21) Appl. No.: 19/560,534

(22) Filed: Mar. 9, 2026

(30) Foreign Application Priority Data
Mar. 12, 2025 (JP) 2025-039548

(51) Int. Cl. H04L 12/12; B60R 16/023; H04L 12/40

(52) U.S. Cl. CPC H04L 12/12; B60R 16/0231; H04L 12/40039

(57) ABSTRACT

A communication system mounted on a movable object is provided. The communication system includes multiple electronic control units and a management device arranged to be communicable with each other. At least one of the electronic control units is activated by supply of power from an outside, and stopped by cutoff of the power from the outside. The at least one of the electronic control units in a state of being supplied with the power is activated by switching over to a wake-up state and is stopped by switching over to a sleep state based on a communication frame received from the outside via a communication line. The communication system further includes a state retention unit that executes a retention operation to retain the wake-up state, wherein input of predetermined control information triggers execution of the retention operation.

### CROSS-REFERENCE TO RELATED APPLICATIONS

This application is based on Japanese Patent Application No. 2025-039548 filed in Japan on Mar. 12, 2025. The entire disclosure of the above application is sincorporated herein by reference.

### TECHNICAL FIELD

The present disclosure relates to a communication system mounted on a movable object, an electronic control unit used in the communication system, an electronic control unit, a wake-up retention program stored on a non-transitory storage medium, and a wake-up retention method. The communication system includes multiple electronic control units and a management device arranged to be communicable therebetween.

### BACKGROUND

A vehicle includes a number of electronic control units (hereinafter referred to as ECUs) to control onboard equipment. A technology is known to reduce power consumption of a communication system for a vehicle as a whole by transitioning some unnecessary ECUs from a wake-up state to a sleep state.

### SUMMARY

According to an aspect of the present disclosure, a communication system mounted on a movable object includes multiple electronic control units and a management device arranged to be communicable with each other. At least one of the electronic control units is activated by supply of power from an outside, and stopped by cutoff of the power from the outside. The at least one of the electronic control units in a state of being supplied with the power is activated by switching over to a wake-up state and is stopped by switching over to a sleep state based on a communication frame received from the outside via a communication line. The communication system executes a retention operation to retain the wake-up state, wherein input of predetermined control information triggers execution of the retention operation.

### BRIEF DESCRIPTION OF DRAWINGS

Objects, features and advantage of the present disclosure will become apparent from the following detailed description made with reference to the accompanying drawings.

FIG. 1 is a diagram schematically illustrating a communication system according to one embodiment.

FIG. 2 is a diagram schematically illustrating of a configuration of a management device in the communication system according to one embodiment.

FIG. 3 is a diagram schematically illustrating a configuration common to multiple ECUs in the communication system according to one embodiment.

FIG. 4 is a state transition diagram illustrating an example of a scene of a vehicle as a whole according to one embodiment.

FIG. 5 is a diagram Part 1 schematically illustrating functions of the electronic control unit according to one embodiment.

FIG. 6 is a diagram Part 2 schematically illustrating functions of the electronic control unit according to one embodiment.

FIG. 7 is a diagram illustrating a specific example of an NM frame transmitted by a state retention unit according to one embodiment.

FIG. 8 is a diagram illustrating a specific example of an NM frame for switching over all of a mobility computer and other ECUs to a wake-up state according to one embodiment.

FIG. 9 is a diagram illustrating a specific example of an NM frame for switching over one or more of a mobility computer and other ECUs to the wake-up state according to one embodiment.

FIG. 10 is a diagram illustrating a first combination pattern of functions of the state retention unit according to one embodiment.

FIG. 11 is a diagram illustrating a second combination pattern of functions of the state retention unit according to one embodiment.

FIG. 12 is a diagram illustrating a third combination pattern of functions of the state retention unit according to one embodiment.

FIG. 13 is a diagram illustrating the operation of the state retention unit at a time of communication cutoff according to one embodiment.

FIG. 14 is a sequence diagram at a time of communication cutoff according to one embodiment.

FIG. 15 is a sequence diagram in a case of releasing a retention operation according to one embodiment.

FIG. 16 is a diagram schematically illustrating a communication system employing control information according to a first modification.

FIG. 17 is a diagram schematically illustrating a communication system employing control information according to a second modification.

FIG. 18 is a diagram schematically illustrating control information according to one embodiment, the first modification and the second modification.

### DETAILED DESCRIPTION

A vehicle, which is an example of a movable object, includes a number of electronic control units (referred to also as ECUs) to control onboard equipment, and these ECUs are connected to a communication bus to form a communication system. In this type of communication system, a technology is known to reduce power consumption of the system as a whole by transitioning some unnecessary ECUs from a wake-up state to a sleep state. A configuration that performs relay control for each system is known as means for activating and stopping the ECU.

In contrast to a configuration that performs mechanical relay control, there is a technology in recent years that adopts high-performance semiconductor power switches also known as IPDs to configure a variety of power states using software in a dynamic and low power consumption manner. IPD is an abbreviation for Intelligent Power Device. In a configuration employing the IPD, it is possible to control supply of power on an ECU-by-ECU basis by combining an activation stop control via a relay based on ON/OFF of the IPD and an activation stop control by switching over to a wake-up state or a sleep state based on a communication frame.

However, in a case of multi-stage control, if a communication frame, which is an external factor for activation, is cut off due to a communication error or another reason, the ECU supposed to be in the wake-up state may be wrongly switched over to the sleep state. If such an event occurs, safety of the vehicle or vehicle occupants may be degraded due to functionality loss.

The present disclosure is made in view of the foregoing and has an object to provide a communication system, an electronic control unit, a wake-up retention program, and a wake-up retention method that can prevent an electronic control unit from being wrongly switched over to a sleep mode.

According to a first aspect of the present disclosure, a communication system mounted on a movable object is provided that includes a plurality of electronic control units and a management device arranged to be communicable therebetween. At least one of the plurality of electronic control units is activated by supply of power from an outside thereof, and stopped by cutoff of the power from the outside. The at least one of the plurality of electronic control units in a state of being supplied with the power is activated by switching over to a wake-up state and is stopped by switching over to a sleep state based on a communication frame received from the outside thereof via a communication line. The communication system further includes a state retention unit that executes a retention operation to retain the wake-up state, wherein input of predetermined control information triggers execution of the retention operation.

According to a second aspect of the present disclosure, an electronic control unit in a communication system mounted on a movable object is provided. The communication system includes a plurality of electronic control units and a management device arranged to be communicable therebetween, and the electronic control unit is included in the plurality of electronic control units. The electronic control unit being configured such that: the electronic control unit is activated by supply of power from an outside thereof, and stopped by cutoff of the power from the outside; the electronic control unit in a state of being supplied with the power is activated by switching over to a wake-up state and is stopped by switching over to a sleep state based on a communication frame received from the outside thereof via a communication line; and the electronic control unit executes a retention operation to retain the wake-up state, wherein input of predetermined control information triggers execution of the retention operation.

According to a third aspect of the present disclosure, a wake-up retention program stored on a non-transitory storage medium for an electronic control unit in a communication system mounted on a movable object is provided. The communication system includes a plurality of electronic control units and a management device arranged to be communicable therebetween, and the electronic control unit is included in the plurality of electronic control units. The wake-up retention program causes the electronic control unit to perform: activating by supply of power from an outside thereof and stopping by cutoff of the power from the outside; in a state of being supplied with the power, activating by switching over to a wake-up state and stopping by switching over to a sleep state based on a communication frame received from the outside thereof via a communication line; and executing a retention operation to retain the wake-up state, wherein input of predetermined control information triggers execution of the retention operation.

According to a fourth aspect of the present disclosure, a wake-up retention method executed by an electronic control unit in a communication system mounted on a movable object is provided. The communication system includes a plurality of electronic control units and a management device arranged to be communicable therebetween, and the electronic control unit is included in the plurality of electronic control units. The wake-up retention method includes: the electronic control unit activating by supply of power from an outside thereof and stopping by cutoff of the power from the outside; the electronic control unit in a state of being supplied with the power activating by switching over to a wake-up state and stopping by switching over to a sleep state based on a communication frame received from the outside thereof via a communication line; and the electronic control unit executing a retention operation to retain the wake-up state, wherein input of predetermined control information triggers execution of the retention operation.

According to the above configuration, even if the communication frame is cut off due to a communication error or another reason, the electronic control unit supposed to be in the wake-up state can be prevented from switching over to the sleep state. Specifically, the above configuration can prevent the electronic control unit from being wrongly switched over to the sleep mode.

One embodiment of a communication system will be described below with reference to the drawings.

### Configuration of communication system

A communication system 1 of the present embodiment is mounted on a vehicle such as an automobile T. The vehicle is an example of a movable object. The communication system 1 is based on a well-known zone architecture and includes a management unit and multiple ECUs arranged according to divisions called zones indicating mounting locations which are, for example, a front portion, a rear portion, a left portion and a right portion of the vehicle body. As described in detail below, the management unit and the multiple ECUs are arranged so as to be communicable therebetween.

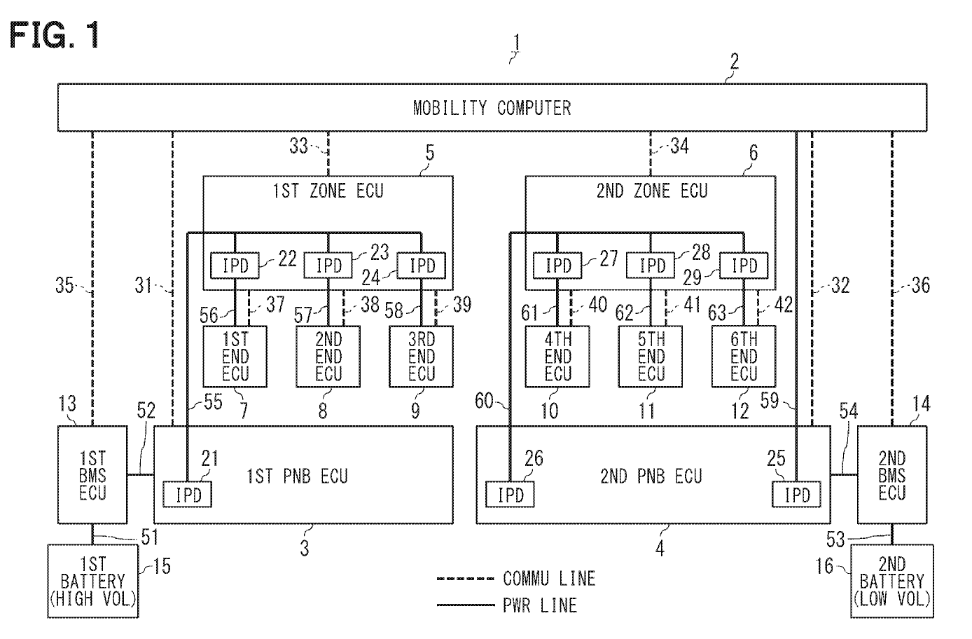

As shown in FIG. 1, the communication system 1 includes various ECUs, including a mobility computer 2, a first PNB ECU 3, a second PNB ECU 4, a first zone ECU 5, a second zone ECU 6, a first end ECU 7, a second end ECU 8, a third end ECU 9, a fourth end ECU 10, a fifth end ECU 11, a sixth end ECU 12, a first BMS ECU 13, and a second BMS ECU 14.

PNB is an abbreviation for Power Net Box, and BMS is an abbreviation for Battery Management System. In the following description and drawings, "PNB ECU" and "BMS ECU" may be referred to simply as "PNB" and "BMS", so that the ECU at the end may be omitted. In the following description, the first PNB 3, the second PNB 4, the first zone ECU 5, the second zone ECU 6, the first end ECU 7, the second end ECU 8, the third end ECU 9, the fourth end ECU 10, the fifth end ECU 11, the sixth end ECU 12, the first BMS 13 and the second BMS 14 are referred to collectively as "multiple ECUs" or "each ECU".

The first PNB 3, the second PNB 4, the first zone ECU 5, the second zone ECU 6, the first BMS 13 and the second BMS 14 are all communicably connected to the mobility computer 2. The first end ECU 7, the second end ECU 8 and the third end ECU 9 are communicably connected to the first zone ECU 5. The fourth end ECU 10, the fifth end ECU 11 and the sixth end ECU 12 are communicably connected to the second zone ECU 6.

FIG. 1 illustrates a case where the number of zone ECUs communicably connected to the mobility computer 2 is two, but the number of zone ECUs communicably connected to the mobility computer 2 may be one or three or more. Although FIG. 1 illustrates the case of three end ECUs communicably connected to each of the first zone ECU 5 and the second zone ECU 6, the number of end ECUs communicably connected to each of the first zone ECU 5 and the second zone ECU 6 may be two or less or four or more.

The mobility computer 2, the first PNB 3, the second PNB 4, the first zone ECU 5, the second zone ECU 6,the first end ECU 7, the second end ECU 8, the third end ECU 9, the fourth end ECU 10, the fifth end ECU 11 and the sixth end ECU 12 are activated by receiving power supplied from a first battery 15 or a second battery 16 via IPDs 21 to 29 and stopped by cutoff of the supplied power. The first battery 15 and the second battery 16 are examples of power supply, which will be described in detail below. The IPDs 21 to 29 are examples of relays, which will be described in detail below. When the description is given on a matter common to the IPDs 21 to 29, the reference numerals at the end may be omitted, so that the IPDs 21 to 29 may be referred to collectively as IPDs.

Among the multiple ECUs, each of the first PNB 3, the second PNB 4, the first zone ECU 5 and the second zone ECU 6 includes the IPD and is an example of a power distribution control unit. Among the multiple ECUs, the mobility computer 2 is an example of a management device. The mobility computer 2 generates an operation control request for controlling the operation of the IPD and outputs the operation control request to the power distribution control unit via communication.

The mobility computer 2 is a control unit that can control operations of the first PNB 3, the second PNB 4, the first zone ECU 5, the second zone ECU 6, the first end ECU 7, the second end ECU 8, the third end ECU 9, the fourth end ECU 10, the fifth end ECU 11, the sixth end ECU 12, the first BMS 13 and the second BMS 14. The mobility computer 2 and the first PNB 3 are communicably connected to each other via a communication line 31. The mobility computer 2 and the second PNB 4 are communicably connected to each other via a communication line 32. The mobility computer 2 and the first zone ECU 5 are communicably connected to each other via a communication line 33. The mobility computer 2 and the second zone ECU 6 are communicably connected to each other via a communication line 34.

The mobility computer 2 and the first BMS 13 are communicably connected to each other via a communication line 35. The mobility computer 2 and the second BMS 14 are communicably connected to each other via a communication line 36. The first zone ECU 5 and the first end ECU 7 are communicably connected to each other via a communication lines 37. The first zone ECU 5 and the second end ECU 8 are communicably connected to each other via a communication line 38. The first zone ECU 5 and the third end ECU 9 are communicably connected to each other via a communication line 39.

The second zone ECU 6 and the fourth end ECU 10 are communicably connected to each other via a communication line 40. The second zone ECU 6 and the fifth end ECU 11 are communicably connected to each other via a communication line 41. The second zone ECU 6 and the sixth end ECU 12 are communicably connected to each other via a communication line 42. Each of the communication lines 31 to 42 is a communication line for communications based on communication frames conforming to a communication protocol such as CAN, CAN FD, or the like, and is also referred to as a communication bus. CAN is an abbreviation for Controller Area Network, and CAN FD is an abbreviation for CAN With Flexible Data Rate.

The first BMS 13 monitors and controls a state of the first battery 15, which is, for example, a battery mounted on the vehicle. The first battery 15 is an example of a power supply and an example of a high voltage power supply having a relatively high voltage value. By the first BMS 13, the power supplied from the first battery 15 via a power line 51 is distributed to the first PNB 3 via a power line 52. By the first PNB 3, the power supplied from the first battery 15 via the first BMS 13 is distributed to the first zone ECU 5, and distributed to the first end ECU 7, the second end ECU 8 and the third end ECU 9 via the first zone ECU 5.

The second BMS 14 monitors and controls the state of the second battery 16, which is, for example, the battery mounted on the vehicle. The second battery 16 is an example of a power supply and an example of a low-voltage power supply having a relatively low voltage value. By the second BMS 14, the power supplied from the second battery 16 via a power line 53 is distributed to the second PNB 4 via a power line 54. By the second PNB 4, the power supplied from the second battery 16 via the second BMS 14 is distributed to the mobility computer 2 and the second zone ECU 6, and distributed to the fourth end ECU 10, the fifth end ECU 11 and the sixth end ECU 12 via the second zone ECU 6.

The first PNB 3 and the first zone ECU 5 are connected to each other via a power line 55 so that the power is distributable. The first PNB 3 includes the IPD 21 interposed between the power line 52 and the power line 55. The IPD is a high-performance semiconductor power switch including a built-in protection circuit and capable of absorbing energy from an inductive load or another source. The IPD is also called a semiconductor fuse, IPS, a smart switch, and a high-side/low-side switch. IPS is an abbreviation for Intelligent Power switch. Compared to a mechanical relay having a mechanical contact, the IPD does not have the mechanical contact and thus has advantages of superior mechanical durability and quietness, as well as compact size. In addition, the IDP has a protection function that does not exist in the mechanical relay, thus ensuring a high level of reliability.

The first PNB 3 turns ON and OFF the IPD 21 based on an operation control request for the IPD 21 provided from the mobility computer 2 via the communication line 31, and switches over the first zone ECU 5 between a power-supplied state a power-cutoff state. Specifically, by turn ON of the IPD 21, the supply of power from the first PNB 3 to the first zone ECU 5 starts. By turn OFF of the IPD 21, the supply of power from the first PNB 3 to the first zone ECU 5 ends. The operation control request is for controlling the operation of the IPD and includes an IPD ON signal for instructing the ON of the IPD and an IPD OFF signal for instructing the OFF of the IPD.

The first zone ECU 5 and the first end ECU 7 are connected to each other via a power line 56 so that the power is distributable. The first zone ECU 5 and the second end ECU 8 are connected to each other via a power line 57 so that the power is distributable. The first zone ECU 5 and the third end ECU 9 are connected to each other via a power line 58 so that the power is distributable. The first zone ECU 5 includes the IPD 22 interposed between the power line 55 and the power line 56, the IPD 23 interposed between the power line 55 and the power line 57, and the IPD 24 interposed between the power line 55 and the power line 58.

The first zone ECU 5 turns ON and OFF the IPD 22 based on the operation control request for the IPD 22 provided from the mobility computer 2 via the communication line 33, and switches over the first end ECU 7 between the power-supplied state and the power-cutoff state. Specifically, by turn ON of the IPD 22, the supply of power from the first zone ECU 5 to the first end ECU 7 starts. By turn OFF of the IPD 22, the supply of power from the first zone ECU 5 to the first end ECU 7 ends.

The first zone ECU 5 turns ON and OFF the IPD 23 based on the operation control request for the IPD 23 provided from the mobility computer 2 via the communication line 33, and switches over the second end ECU 8 between the power-supplied state and the power-cutoff state. Specifically, by turn ON of the IPD 23, the supply of power from the first zone ECU 5 to the second end ECU 8 starts. By turn OFF of the IPD 23, the supply of power from the first zone ECU 5 to the second end ECU 8 ends.

The first zone ECU 5 turns ON and OFF the IPD 24 based on an operation control request for the IPD 24 provided from the mobility computer 2 via the communication line 33, and switches over the third end ECU 9 between the power-supplied state and the power-cutoff state. Specifically, by turn ON of the IPD 24, the supply of power from the first zone ECU 5 to the third end ECU 9 starts. By turn OFF of the IPD 24, the supply of power from the first zone ECU 5 to the third end ECU 9 starts.

The second PNB 4 and the mobility computer 2 are connected to each other via a power line 59 so that the power is distributable. The second PNB 4 includes the IPD 25 interposed between the power line 54 and the power line 59. The IPD 25 is basically always in ON, and the power from the second battery 16 is always supplied to the mobility computer 2. In the present embodiment, the IPD 25 is basically always ON. However, the IPD 25 may be turned OFF. For example, when the vehicle is not used for a long period of time, for example, for transportation by ship, the IPD 25 may be temporarily turned OFF to reduce a dark current flowing to the mobility computer 2, so that the power consumption of the second battery 16 can be reduced.

When the IPD 25 is temporarily turned OFF, the supply of power from the second battery 16 to the mobility computer 2 is stopped. So that the IPD 25 can be turned from OFF to ON, the mobility computer 2 may operate in a low-power consumption state by a battery during the period of time during which the supply of power to the mobility computer 2 is stopped. The system may be configured so that the mobility computer 2 and the second battery 16 are directly connected so that the power from the second battery 16 is always supplied to the mobility computer 2. In this case, the power line 59 and the IPD 25 may be omitted.

The second PNB 4 and the second zone ECU 6 are connected to each other via a power line 60 so that the power is distributable. The second PNB 4 includes the IPD 26 interposed between the power line 54 and the power line 60. The second PNB 4 turns ON and OFF the IPD 26 based on the operation control request for the IPD 26 provided from the mobility computer 2 via the communication line 34, and switches over the second zone ECU 6 between the power-supplied state and the power-cutoff state. Specifically, by turn ON of the IPD 26, the supply of power from the second PNB 4 to the second zone ECU 6 starts. By turn OFF of the IPD 26, the supply of power from the second PNB 4 to the second zone ECU 6 ends.

The second zone ECU 6 and the fourth end ECU 10 are connected to each other via a power line 61 so that the power is distributable. The second zone ECU 6 and the fifth end ECU 11 are connected to each other via a power line 62 so that the power is distributable. The second zone ECU 6 and the sixth end ECU 12 are connected to each other via a power line 63 so that the power is distributable. The second zone ECU 6 includes the IPD 27 interposed between the power line 60 and the power line 61, the IPD 28 interposed between the power line 60 and the power line 62, and the IPD 29 interposed between the power line 60 and the power line 63.

The second zone ECU 6 turns ON and OFF the IPD 27 based on an operation control request for the IPD 27 provided from the mobility computer 2 via the communication line 34, and switches over the fourth end ECU 10 between the power-supplied state and the power-cutoff state. Specifically, by turn ON of the IPD 27, the supply of power from the second zone ECU 6 to the fourth end ECU 10 starts. By turn OFF of the IPD 27, the supply of power from the second zone ECU 6 to the fourth end ECU 10 ends.

The second zone ECU 6 turns ON and OFF the IPD 28 based on the operation control request for the IPD 28 provided from the mobility computer 2 via the communication line 34, and switches over the fifth end ECU 11 between the power-supplied state and the power-cutoff state. Specifically, by turn ON of the IPD 28, the supply of power from the second zone ECU 6 to the fifth end ECU 11 starts. By turn OFF of the IPD 28, the supply of power from the second zone ECU 6 to the fifth end ECU 11 ends.

The second zone ECU 6 turns ON and OFF the IPD 29 based on the operation control request for the IPD 29 provided from the mobility computer 2 via the communication line 34, and switches over the sixth end ECU 12 between the power-supplied state and the power-cutoff state. Specifically, by turn ON of the IPD 29, the supply of power from the second zone ECU 6 to the sixth end ECU 12 starts. By turn OFF of the IPD 29, the supply of power from the second zone ECU 6 to the sixth end ECU 12 ends.

### Activation stop control in communication system

The communication system 1 combines an activation stop control via a relay based on ON/OFF of the IPD and an activation stop control by switching to the wake-up state or the sleep state based on the communication frame. In the following description, the former of the two activation stop controls is referred to as activation stop control via relay and the latter is referred to as activation stop control based on communication frame. The communication frame described above is also called a NM frame or a NM message. NM is an abbreviation for Network Management.

The activation stop control via relay includes an activation control via relay based on ON of the IPD and a stop control via relay based on OFF of the IPD. The activation stop control based on communication frame includes an activation control by switching over from the sleep state to the wake-up state based on the communication frame for a wake-up request and a stop control by switching over from the wake-up state to the sleep state based on the communication frame for a sleep request.

The activation stop control via relay uses an operation control request, i.e., an IPD ON signal for instructing ON of the IPD and an IPD OFF signal for instructing OFF of the IPD. Specifically, the ECU having received the IPD ON signal from the mobility computer 2 turns ON the IPD specified by the received IPD ON signal and starts supplying the power to the ECU connected to the turned-ON IPD as the power distribution target. The ECU having received the IPD OFF signal from the mobility computer 2 turns OFF the IPD specified by the received IPD OFF signal and ends supplying the power to the ECU connected to the turned-OFF IPD as the power distribution target.

The activation stop control based on communication frame uses the value of a predetermined bit in the data field of the communication frame. For example, the communication frame including "1" at the predetermined bit of the data field is used as the communication frame for a wake-up request, and the communication frame including "0" at the predetermined bit of the data field is used as the communication frame for a sleep request. Specifically, the ECU having received the communication frame from the mobility computer 2 determines the value stored at the predetermined bit of the data field of the received communication frame. If the value is "1", the ECU transitions from the sleep state to the wake-up state or keeps the wake-up state. If the value is "0", the ECU transitions from the wake-up state to the sleep state or keeps the sleep state.

In the present embodiment, the ECU keeps the wake-up state as long as the ECU periodically receives the communication frame for a wake-up request from the mobility computer 2 at given periods for example. Upon elapse of a certain period of time during which receipt of the communication frame for a wake-up request is absent, the ECU transitions from the wake-up state to the sleep state. The wake-up state may be a normal operating state in which functions assigned to the ECU are available without limitation. The sleep state may be a low-power consumption operating state in which there is a limitation on available functions. In the present embodiment, the communication frame is not limited to being transmitted from the mobility computer 2, and may also be transmitted from another ECU.

The activation stop control via relay performed by the mobility computer 2 incudes: transmitting the IPD ON signal to an ECU arranged in a higher level than a control target ECU to turn ON the IPD, thereby performing the activation control on the control target ECU; and transmitting the IPD OFF signal to turn OFF the IPD, thereby performing the stop control on the control target ECU. For example, when the control target ECU is the first zone ECU 5, the mobility computer 2 transmits the IPD ON signal to the first PNB 3 arranged in the higher level than the first zone ECU 5 to turn ON the IPD 21, thereby activating the first zone ECU 5, and transmits the IPD OFF signal to turn OFF the IPD 21, thereby stopping the first zone ECU 5.

For example, when the control target ECU is the first end ECU 7, the mobility computer 2 transmits the IPD ON signal to the first zone ECU 5 arranged in the higher level than the first end ECU 7 to turn ON the IPD 22, thereby activating the first end ECU 7, and transmits the IPD OFF signal to turn OFF the IPD 22, thereby stopping the first end ECU 7.

The activation stop control based on communication frame performed by the mobility computer 2 includes: transmitting the communication frame for a wake-up request destined for the control target ECU, thereby transitioning the control target ECU to the sleep state; transmitting the communication frame for a wake-up request destined for the control target ECU, thereby transitioning the control target ECU to the wake-up state. For example, when the control target ECU is the first zone ECU 5, the mobility computer 2 transmits the communication frame for a wake-up request destined for the first zone ECU 5, thereby transitioning the first zone ECU 5 to the wake-up state, and transmits the communication frame for a sleep request destined for the first zone ECU 5, thereby transitioning the first zone ECU 5 to the sleep state.

For example, when the control target ECU is the first end ECU 7, the mobility computer 2 transmits the communication frame for a wake-up request destined for the first end ECU 7, thereby transitioning the first end ECU 7 to the wake-up state, and transmits the communication frame for a wake-up request destined for the first end ECU 7, thereby transitioning the first end ECU 7 to the sleep state. The ECU to which the supply of power has started due to the turn ON of the IPD arranged in the higher level autonomously becomes the wake-up state, and therefore, it is not necessary for the mobility computer 2 to transmit the communication frame for a wake-up request to this ECU.

As described above, in the present embodiment, the ECUs are activated by supply of supply from the outside thereof and deactivated (stopped) by cutoff of the power from the outside. Furthermore, the ECUs in the state of being supplied with the power is activated by switching over to the wake-up state based on the communication frame received from the outside via the communication line and is stopped by switching over to the sleep state based on the communication frame received from the outside via the communication line.

### Configuration of management device.

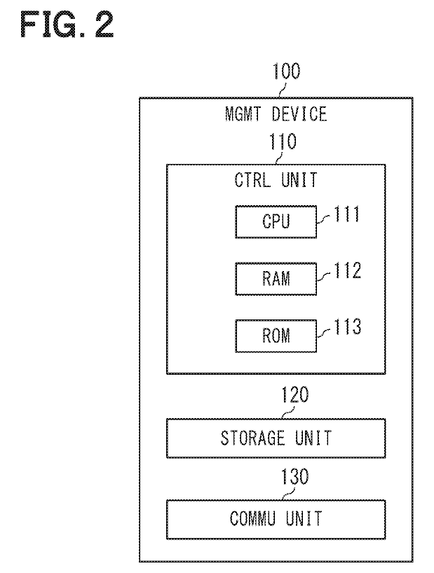

The configuration of the mobility computer 2 being an example of the management device in the communication system 1 will be described below with reference to FIG. 2. In the following, by way of example, the mobility computer 2 represents the management device 100 to describe the configuration of the management device 100 according to the present embodiment. As shown in FIG. 2, the management device 100 includes a control unit 110, a storage unit 120, and a communication unit 130.

The control unit 110 is a device that performs various calculation processes and other processing related to the operation of the management device 100, etc., and includes a microcomputer as a main component thereof, the microcomputer including, for example, a CPU 111, a RAM 112, and a ROM 113. Various functions of the control unit 110 are implemented by the CPU 111 executing a program stored in a non-transitory tangible storage medium. The non-transitory substantive storage medium is, for example, the ROM 113. When the program is executed by CPU 111, a method corresponding to the program is performed.

The number of microcomputers in the control unit 110 may be one or more. The various functions of the control unit 110 is not limited to being implemented by software. Part or all of elements of the functions may be implemented using one or more hardware pieces. For example, when the above function is implemented by a hardware electronic circuit, the electronic circuit may be a digital circuit including a number of logic circuit, or an analog circuit, or a combination of the digital circuit and the analog circuit. The storage unit 120 is, for example, a nonvolatile memory, such as a flash memory or an EEPROM, that can be rewritten with various data. The communication unit 130 controls data communication with another ECU.

### Configuration of each ECU.

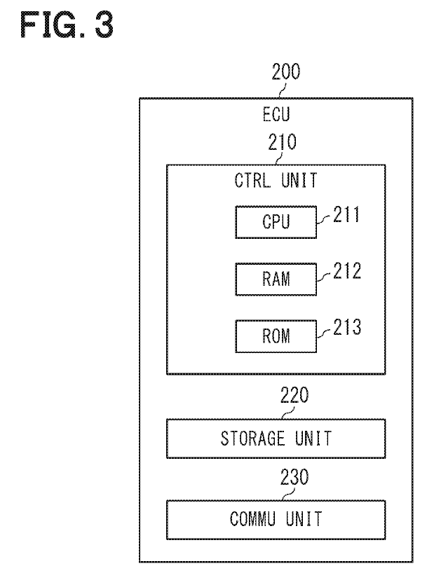

The configuration common to multiple ECUs in the communication system 1 will be described below with reference to FIG. 3. In the following, by way of example, an ECU 200 represents any one of the multiple ECUs to describe the configuration common to the multiple ECUs. As shown in FIG. 3, the ECU 200 includes a control unit 210, a storage unit 220, and a communication unit 230.

The control unit 210 is a device that performs various calculation processes and other processing related to the operation of the ECU 200, etc., and includes a microcomputer as a main component thereof, the microcomputer including, for example, a CPU 211, a RAM 212, and a ROM 213. Various functions of the control unit 210 are implemented by the CPU 211 executing a program stored in a non-transitory tangible storage medium. The non-transitory tangible storage medium is, for example, the ROM 213. When the program is executed by CPU 211, a method corresponding to the program is executed. The programs and methods described above include a wake-up retention program and a wake-up retention method related to the below-described retention operation.

The number of microcomputers in the control unit 210 may be one or more. The various functions of the control unit 210 is not limited to being implemented by software. Part or all of elements of the functions may be implemented using one or more hardware pieces. For example, when the above function is implemented by a hardware electronic circuit, the electronic circuit may be a digital circuit including a number of logic circuit, or an analog circuit, or a combination of the digital circuit and the analog circuit. The storage unit 220 is, for example, a nonvolatile memory, such as a flash memory or an EEPROM, that can be rewritten with various data. The communication unit 230 controls data communication with another ECU.

### Activation stop control based on scene.

In the communication system 1, an activation stop control based on scene is performed. In the activation stop control based on scene, the mobility computer 2 manages scenes related to vehicle behaviors. When an activation request or a stop request for the control target ECU is generated, the mobility computer 2 determines based on a transition destination scene whether or not to perform the activation stop control via relay and whether or not to perform the activation stop control based on communication frame. In the following description, ON of the IPD is also referred to as relay-on and OFF of the IPD is also referred to as relay-off.

The mobility computer 2 manages functions in scenes. When a start/stop request is generated for the control target ECU, the mobility computer 2 determines based on type of the scene whether or not to perform the activation stop control via relay and whether or not to perform the activation stop control based on communication frame. Here, the scene encompasses concept of vehicle state and function. The vehicle state encompasses concept of state of vehicle such as parked, boarding, driving, etc., and further encompasses concept of vehicle power state such as +B state, ACC state, IG state, etc. The function encompasses concept of a function executed by so-called an application, and further encompasses concept of subsystem configured by one or more ECUs.

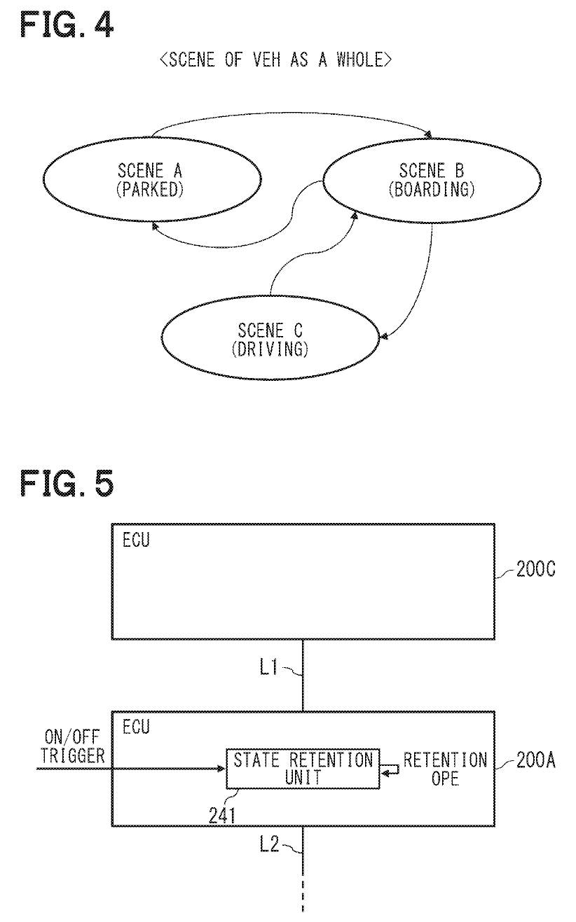

As shown in FIG. 4, it is assumed that a scene A, a scene B, and a scene C are scenes for the vehicle as a whole and that a state transition between the scene A and the scene B occurs and a state transition between the scene B and the scene C occurs. The scene A is, for example, a parked state. The scene B is, for example, a boarding state. The scene C is, for example, a driving state. The scene is determined by the mobility computer 2 and stored in the storage unit 120.

### Management of vehicle power state.

The communication system 1 manages a vehicle power state representing the power state of the vehicle as a whole. Each ECU retains information indicative of the vehicle power state. The information indicative of the vehicle power state retained in each ECU is also called a self-retaining vehicle power state. In the management of the vehicle power state, each ECU sets the self-retaining vehicle power state to “undefined” at a time of activating and keeps the self-retaining vehicle power state at “undefined” until acquiring latest vehicle power state information from the mobility computer 2. The vehicle power state is synonymous with the scene described with reference to FIG. 4. Specifically, the parked scene is synonymous with the vehicle power state "parked," the boarding scene is synonymous with the vehicle power state "boarding" and the driving scene is synonymous with the vehicle power state "driving.

After determining the vehicle power state information, the mobility computer 2 transmits the determined vehicle power state information to the first PNB 3, the second PNB 4, the first zone ECU 5, the second zone ECU 6, the first BMS 13 and the second BMS 14. This transmission of the power state information is performed periodically. Upon receipt of the vehicle power state information transmitted from the mobility computer 2, the first zone ECU 5 transmits the received vehicle power state information to the first end ECU 7, the second end ECU 8 and the third end ECU 9. Upon receipt of the vehicle power state information transmitted from the mobility computer 2, the second zone ECU 6 transmits the received vehicle power state information to the fourth end ECU 10, the fifth end ECU 11 and the sixth end ECU 12.

When the self-retaining vehicle power state is “undefined,” each ECU operates only the minimum function such as communication reception. Upon acquiring the latest vehicle power state information from the mobility computer 2, each ECU keeps or updates the self-retaining vehicle power state based on the acquired information. If the latest vehicle power state information acquired from the mobility computer 2 indicates a state-transition-in-progress, each ECU sets the self-retaining power state to the state-transition-in-progress, thereby updating to the state-transition-in-progress. The state-transition-in-progress is a state where the state transition is in progress.

The mobility computer 2 performs state transition of the vehicle power state following the scene. When the mobility computer 2 detects a door unlock in the "parked" state, the vehicle power state transitions to the state-transition-in-progress from the "parked" state to the "boarding" indicating that the state transition from the "parked" state to the "boarding" is in progress. When the state transition is completed, the vehicle power state transitions to the "boarding" state. When the mobility computer 2 detects a push-switch on in the "boarding" state, the vehicle power state transitions to the state-transition-in-progress from the "boarding" state to the "driving" state. When the state transition is completed, the vehicle power state transitions to the "driving" state. When the mobility computer 2 detects a push-switch off in the "driving" state, the vehicle power state transitions to the state-transition-in-progress from "driving" to the "boarding" state. When the state transition is completed, the vehicle power state transitions to the "boarding" state. When the mobility computer 2 detects a door lock in the "boarding" state, the vehicle power state transitions to the state-transition-in-progress from the “boarding" state to the "parked" state. When the state transition is completed, the vehicle power state transitions to the "parked" state. When each ECU receives the vehicle power state information from the mobility computer 2, the state of the ECU transitions based on the received vehicle power state information.

### Function of state retention unit.

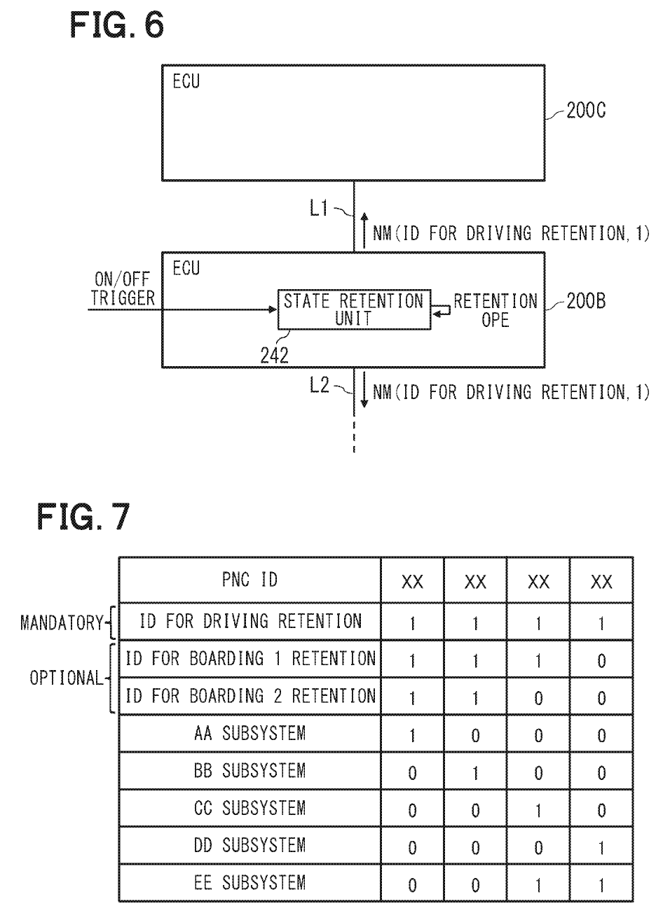

Functions of the state retention unit will be described below with reference to FIGS. 5 and 6. The state retention unit may be provided in multiple ECUs of the communication system 1. In the following, by way of example, an ECU 200A, 200B, 200C represents any one of the ECUs to describe the functions of the state retention unit. In FIGS. 5 and 6, a communication line L1, L2 represents any one of the communication lines 31 to 42.

As shown in FIG. 5, the ECU 200A includes a state retention unit 241 as a functional block that executes a retention operation to retain the wake-up state, wherein input of predetermined control information triggers execution of the retention operation. As shown in FIG. 6, the ECU 200B includes a state retention unit 242 as a functional block that has the same functions as the state retention unit 241. These functional blocks can be implemented by software, by hardware, or by cooperation of software and hardware. As shown in FIGS. 5 and 6, the ECU 200C does not include the state retention unit 241 nor the state retention unit 242.

In the present embodiment, the control information serving as a trigger for the retention operation is the information represented by the communication signal transmitted via the communication line 31 to 42. The control information may be information that changes according to the state or function of the vehicle. Specifically, the control information may be, for example, the vehicle power state information. When the vehicle power state information is used as the control information, the state retention unit 241, 242 executes the retention operation triggered by the input of the vehicle power state information indicating "driving". Specifically, in this case, the vehicle power state information indicating "driving" functions as an ON trigger, and the vehicle power state information indicating other than "driving" functions as an OFF trigger. In the following description, FIGS. 5 and 6, the control information is referred to also as ON/OFF trigger.

When the ON trigger is input to the ECU 200A, 200B in the wake-up state, the state retention unit 241, 242 can keeps the ECU 200A, 200B at the wake-up state without switching over to the sleep state by executing the retention operation, even if the receipt of the communication frame for a wake-up request transmitted periodically from the mobility computer 2 is cut off due to communication cutoff or another reason. Specifically, the state retention unit 241, 242 can execute the retention operation even when the receipt of the communication frame for a wake-up request is cut off for a given period of time. The ECU 200A, 200B can keep the wake-up state by an internal factor for activation, even when the communication frame of the wake-up request, which is an external factor for activation, is cut off due to a communication error or another reason.

In the above configuration, if the communication via the communication line 31 to 42 is cut off, the input of the control information may also be cut off, which may make it difficult to keep the wake-up state. In view of this, when the communication via the communication line 31 to 42 is cut off, the state retention unit 241, 242 determines whether or not the retention operation is to be executed based on the latest value of the vehicle power state information represented by the communication signal. The state retention unit 241, 242 is configured to retain the newest value, i.e., the latest value, of the vehicle power state information.

For example, if the vehicle power state information received immediately before an occurrence of the communication cutoff is information indicating "driving," the state retention unit 241, 242 executes the retention operation after the occurrence of the communication cutoff. For example, if the vehicle power state information received immediately before an occurrence of the communication cutoff is information indicating other than "driving", the state retention unit 241, 242 does not execute the retention operation after the occurrence of the communication cutoff. In this way, the wake-up state can be correctly kept even in the event of communication cutoff.

After executing the retention operation, the state retention unit 241, 242 continues execution of the retention operation if there is no change in the vehicle power state information being the control information, and stops execution of the retention operation if there is a change in the vehicle power state information being the control information. Specifically, the state retention unit 241, 242 periodically determines whether or not the vehicle power state information being the control information has changed, and based on a results of this determination, determines whether to continue or stop the retention operation.

As shown in FIG. 6, upon executing the retention operation, the state retention unit 242 of the ECU 200B transmits, via communication line L1, L2 to the outside, a communication frame for switching over at least part of: the mobility computer 2 and other ECUs to the wake-up state. This activates the communication line L1, L2 being the communication bus and also switches over at least part of: the mobility computer 2 and other ECUs to the wake-up state. Specifically, the state retention unit 242 of the ECU 200B activates not only the ECU 200B but also at least part of other ECUs including the ECU 200C, by using the communication frame of the wake-up request.

In this case, the NM frame being the communication frame transmitted by the state retention unit 242 may be, for example, as shown in FIG. 7. Specifically, for the NM frame, it is possible to set and output a PNC ID for wake-up retention for each scene. PNC is an abbreviation for Partial Network Cluster. For example, the PNC IDs include "ID for driving retention" for a case where the scene is "driving", "ID for boarding-1 retention" and "ID for boarding-2 retention". The "ID for boarding-1 retention" and the "ID for boarding-2 retention" are for a case where the scene is "boarding". The "ID for driving retention" may be mandatory with respect to dealing with a significant event. The "ID for onboard-1 retention" and "ID for onboard-2 retention" may be optional settings and may be used on an as-needed basis.

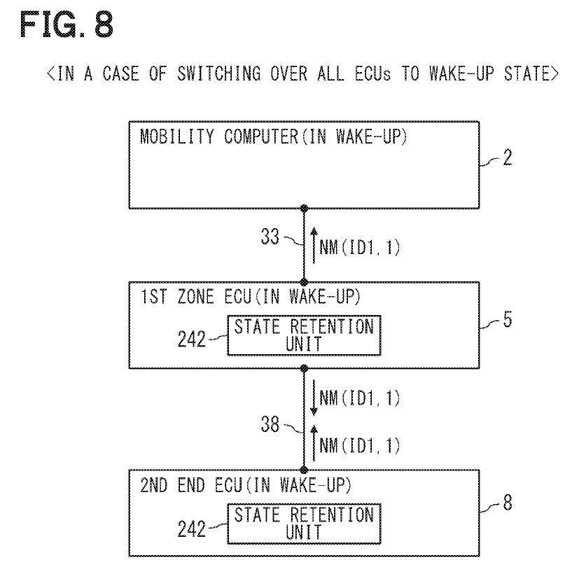

The NM frame being the communication frame transmitted by the state retention unit 242 can be used to switch over all ECUs, including the mobility computer 2 and other ECUs, to the wake-up state. An example of this NM frame will be described with reference to FIG. 8. Although the description will be given on the first zone ECU 5 and the second end ECU 8 by way of example, the same is applicable to others.

In this case, the state retention unit 242 sets the ID 1 for retention as the PNC ID, wherein the ID 1 for retention is common to the mobility computer 2, the first zone ECU 5 and the second end ECU 8. Specifically, the ID1 for retention is common to: the communication line 33 between the mobility computer 2 and the first zone ECU 5; the first zone ECU 5; the communication line 38 between the first zone ECU 5 and the second end ECU 8; and the second end ECU 8.

In this case, when the ON trigger is input, the state retention unit 242 of the first zone ECU 5 transmits "NM (ID1,1)" to the mobility computer 2 and the second end ECU 8, wherein the NM (ID1,1)" represents the NM frame including the ID1 for retention. Further, in this case, when the ON trigger is input, the state retention unit 242 of the second end ECU 8 transmits "NM(ID1,1)" to the first zone ECU 5, wherein the "NM(ID1,1)" represents the NM frame including the ID1 for retention. Because of this, it is possible to keep all the ECUs, including the mobility computer 2, the first zone ECU 5 and the second end ECU 8, at the wake-update consistently.

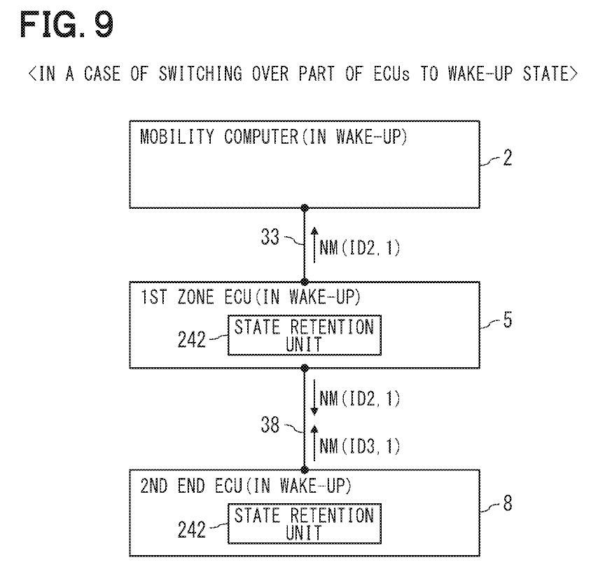

The NM frame being the communication frame transmitted by the state retention unit 242 can be used to switch over part of: the mobility computer 2 and other ECUs to the wake-up state. An example of this NM frame will be described with reference to FIG. 9. Although the description will be given on the first zone ECU 5 and the second end ECU 8 by way of example, the same is applicable to others.

In this case, the state retention unit 242 sets the ID 2 for retention and the ID 3 for retention as the PNC ID, wherein the ID 2 for retention is common to the mobility computer 2 and the first zone ECU 5, and the ID 3 for retention is common to the first zone ECU 5 and the second end ECU 8. Specifically, the ID2 for retention is common to: the 33 communication lines between the mobility computer 2 and the first zone ECU 5; and the first zone ECU 5. Specifically, the ID 3 for retention is common to: the communication line 38 between the first zone ECU 5 and the second end ECU 8; and the second end ECU 8.

In this case, when the ON trigger is input, the state retention unit 242 of the first zone ECU 5 transmits "NM (ID2,1)" being the NM frame including the ID2 for retention to the mobility computer 2 and the second end ECU 8. Further, in this case, when the ON trigger is input, the state retention unit 242 of the second end ECU 8 transmits "NM(ID3,1)" being the NM frame including the ID3 for retention to the first zone ECU 5.

Because of this, it is possible keep only the zone ECUs including the first zone ECU 5 at the wake-up state or keep only the end ECUs including the second end ECU 8 at the wake-up state. Specifically, in this case, the wake-up state of can be kept separately for the zone ECU and the end ECU.

### Combination pattern of functions of state retention unit

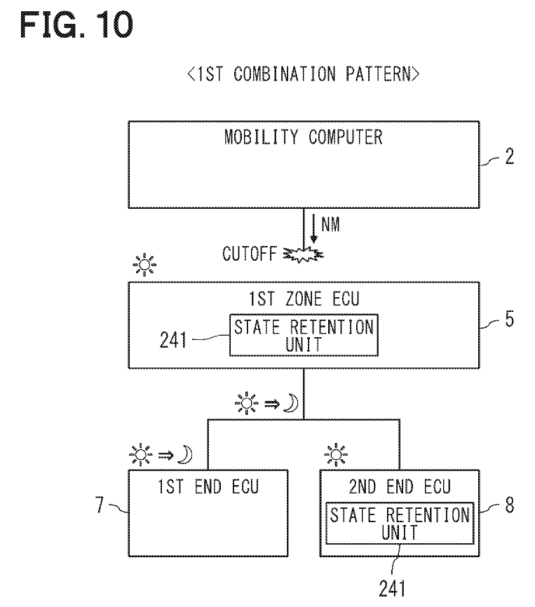

It may be preferable that the state retention unit 241, 242 be provided in ECUs that may lead to occurrence of a significant event in case of communication cutoff, for examples, ECUs that implements functionality of running, turning, stopping, electric power, heat, occupant protection, visibility protection, and entrance/exit systems. In this regard however, it is possible to employ various combinations of functions of the state-retention unit 241, 242, specifically, it is possible to employ various combinations concerning, among the multiple ECUs, which ECU is configured as the same as the ECU 200A, which ECU is configured as the same as the ECU 200B, and which ECU is configured as the same as the ECU 200C. The three patterns of such combinations will be described below with reference to FIGS. 10-12.

Although the description will be given on the first zone ECU 5, the first end ECU 7 and the second end ECU 8 by way of example, the same is applicable to others. In FIGS. 10-12, the symbol imitating the Sun represents the "wake-up state" or "communication available," and the symbol imitating the Moon represents the "sleep state" or "communication unavailable”. In this case, it is assumed that the first zone ECU 5, the first end ECU 7, and the second end ECU 8 are all in the wake-up state before cutoff of the communication between the mobility computer 2 and the first zone ECU 5.

### 1 first combination pattern

As shown in FIG. 10, in the first combination pattern, the first zone ECU 5 includes the state retention unit 241 as is the case with the ECU 200A, the first end ECU 7 does not include the state retention unit 241 nor the state retention unit 242 as is the case with the ECU 200C, and the second end ECU 8 includes a state retention unit 241 as is the case with the ECU 200A. When the first combination pattern is adopted, in the event of communication cutoff, the function of the state retention unit 241 of the first zone ECU 5 can activate only the first zone ECU 5 and the function of the state retention unit 241 of the second end ECU 8 can activate only the second end ECU 8.

Therefore, in this case, it is possible to keep the first zone ECU 5 and the second end ECU 8 at the wake-up state even in the event of communication cutoff. However, the first end ECU 7 becomes the sleep state and the communication between the first zone ECU 5 and the first and second end ECU 8 and between the first zone ECU 5 and the first and second end ECU 7 becomes unavailable.

When the first combination pattern is adopted, even in the event of communication cutoff, functions completable by the ECUs in the wake-up state alone, such as for example, turning, stopping, occupant protection, and visibility protection, are available. However, when the first combination pattern is adopted, in the event of communication cutoff, functions achieved by communication-based cooperation between the zone ECU and the end ECU in the same zone, for example, between the first zone ECU 5 and the first end ECU 7 and between the first zone ECU 5 and the second end ECU 8, are unavailable. The functions achieved via communication-based cooperation between the zone ECU and the end ECU in the same zone include, for example, running, and other entertainment-related functions. This first combination pattern may be suitable for the purpose of making the minimum necessary functions available in the event of communication cutoff and for the purpose of standardizing the specifications for each ECU.

### 2 second combination pattern

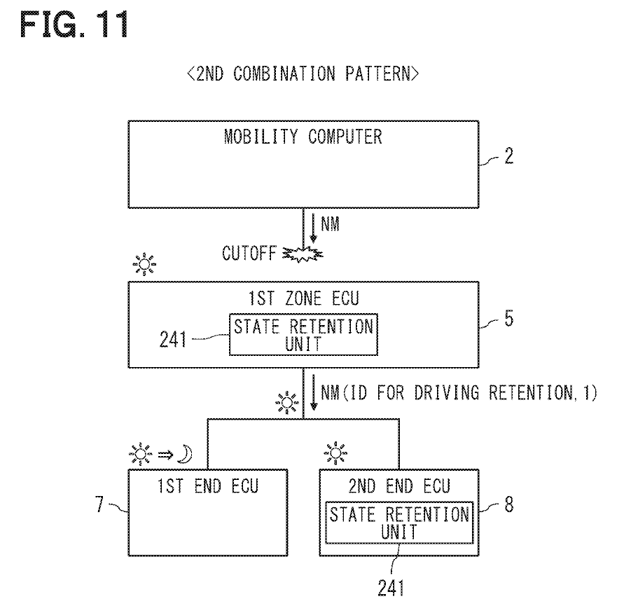

As shown in FIG. 11, in the second combination pattern, the first zone ECU 5 includes the state retention unit 242 as is the case with the ECU 200B, the first end ECU 7 does not include the state retention unit 241 nor the state retention unit 242 as is the case with the ECU 200C, and the second end ECU 8 includes the state retention unit 241 as is the case with the ECU 200A. When the second combination pattern is adopted, in the event of communication cutoff, the function of the state retention unit 242 of the first zone ECU 5 can activate the first zone ECU 5 and the communication line, and the function of the state retention unit 241 of the second end ECU 8 can activate only the second end ECU 8.

Therefore, in this case, the first zone ECU 5 and the second end ECU 8 can keep the wake-up state even in the event of communication cutoff. In this case, the communication between the first zone ECU 5 and the first end ECU 7 and between the first zone ECU 5 and the second end ECU 8 are available in the event of communication cutoff. However, the first end ECU 7 becomes the sleep state.

When the second combination pattern is adopted, even in the event of communication cutoff, functions completable by the ECUs in the wake-up state alone, such as for example, turning, stopping, occupant protection, and visibility protection, are available. In addition, when the second combination pattern is adopted, even in the event of communication breakdown, functions achieved by communication-based cooperation between the zone ECU and the end ECU in the same zone, for example, between the first zone ECU 5 and the first end ECU 7 and between the first zone ECU 5 and the second end ECU 8, are available. The functions achieved via communication-based cooperation between the zone ECU and the end ECU in the same zone include, for example, running, and other entertainment-related functions.

However, if the second combination pattern is adopted, in the event of communication cutoff, functions achieved by communication-based cooperation between the zone ECU and the end ECU via the mobility computer 2 are unavailable. This second combination pattern may be suitable for the purpose of, in the event of communication cutoff, making more functions available than the minimum necessary functions.

### 3 third combination pattern

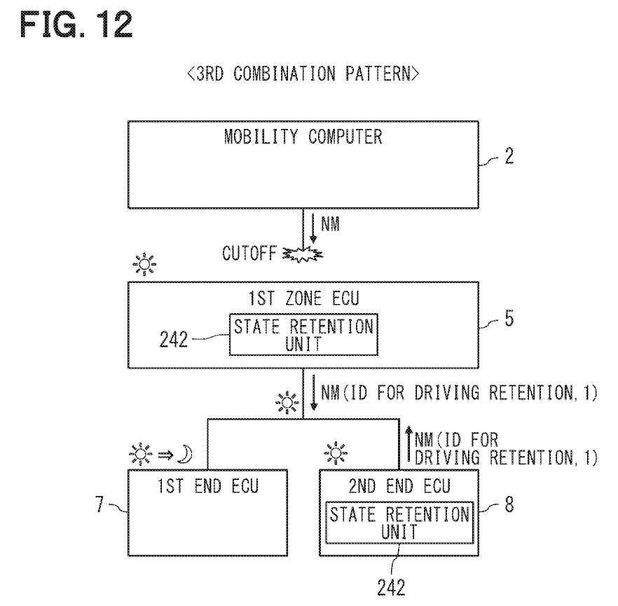

As shown in FIG. 12, in the third combination pattern, the first zone ECU 5 includes the state retention unit 242 as is the case with the ECU 200B, the first end ECU 7 does not include the state retention unit 241 nor the state retention unit 242 as is the case with the ECU 200C, and the second end ECU 8 includes the state retention unit 242 as is the case with the ECU 200B, When the third combination pattern is employed, in the event of communication cutoff, the function of the state retaining part 242 of the first zone ECU 5 can activate the first zone ECU 5 CU and the communication line, and the function of the state retaining part 242 of the second end ECU 8 can activate the second end ECU 8 and the communication line.

Therefore, in this case, the first zone ECU 5 and the second end ECU 8 can keep the wake-up state even in the event of communication cutoff. Further, in this case, the communications between the first zone ECU 5 and the first end ECU 7 and between the first zone ECU 5 and the second end ECU 8 are available. However, the first end ECU 7 becomes the sleep state.

When the third combination pattern is adopted, even in the event of communication cutoff, functions completable by the ECUs in the wake-up state alone, such as for example, turning, stopping, occupant protection, and visibility protection, are available. In addition, when the third combination pattern is adopted, even in the event of communication cutoff, functions achieved by communication-based cooperation between the zone ECU and the end ECU in the same zone, for example, between the first zone ECU 5 and the first end ECU 7 and between the first zone ECU 5 and the second end ECU 8, are available. The functions achieved by communication-based cooperation between the zone ECU and the end ECU in the same zone include, for example, running and other entertainment functions.

However, if the third combination pattern is adopted, in the event of communication cutoff, functions achieved by communication-based cooperation between the zone ECU and the end ECU via the mobility computer 2 are unavailable. This third combination pattern may be suitable for the purpose of, in the event of communication cutoff, making more functions available than the minimum necessary functions and for the purpose of standardizing the specifications for each ECU.

### Operation of state retention unit in the event of communication cutoff

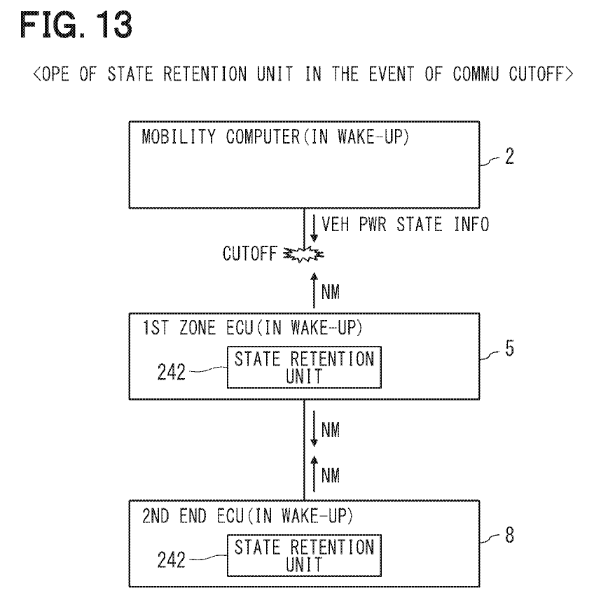

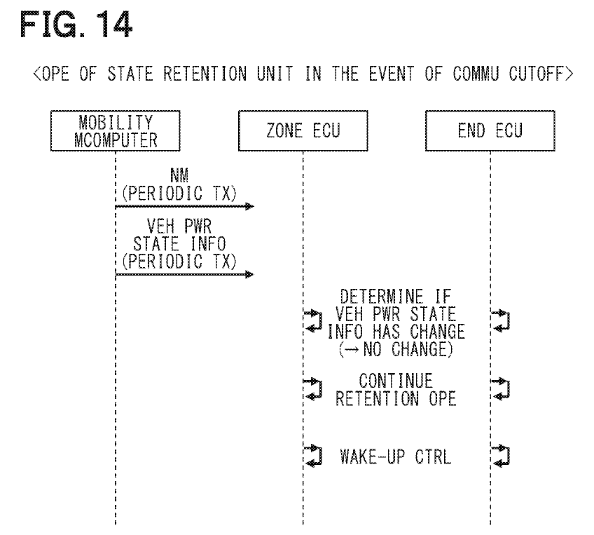

The operation of the state retention unit 242 in the event of communication cutoff will be described with reference to FIGS. 13 and 14. Although the description will be given on the mobility computer 2, the first zone ECU 5 and the second end ECU 8 by way of example, the same is applicable to others. In this case, the first zone ECU 5 and the second end ECU 8 include the state retention unit 242 as is the case with the ECU 200B.

In this case, it is assumed that the communication cutoff occurs when the mobility computer 2, the first zone ECU 5 and the second end ECU 8 are all in the wake-up state and the vehicle power state is "driving".

The mobility computer 2 periodically transmits the NM frame to the first zone ECU 5 and also periodically transmits the vehicle power state information. When the communication cutoff occurs and the transmission of the NM frame and the vehicle power state information is cutoff, the state retention unit 242 in the first zone ECU 5 and the second end ECU 8 executes the following operations. first, the state retention unit 242 determines whether or not there is a change in the vehicle power state information. Next, based on a result of this determination, the state retention unit 242 determines whether to continue or stop the retention operation.

Here, since there is no change in the vehicle power state information, the state retention unit 242 determines to continue the retention operation. Then, the state retention unit 242 of the first zone ECU 5 executes the retention operation to retain the wake-up state of the first zone ECU 5 and the state retention unit 242 of the second zone ECU 8 executes the retention operation to retain the wake-up state of the second zone ECU 8, and the state retention units 242 of the first zone ECU 5 and the second zone ECU 8 transmit the NM frames for waking up other ECUs.

### Timing to stop the retention operation by the state retention unit

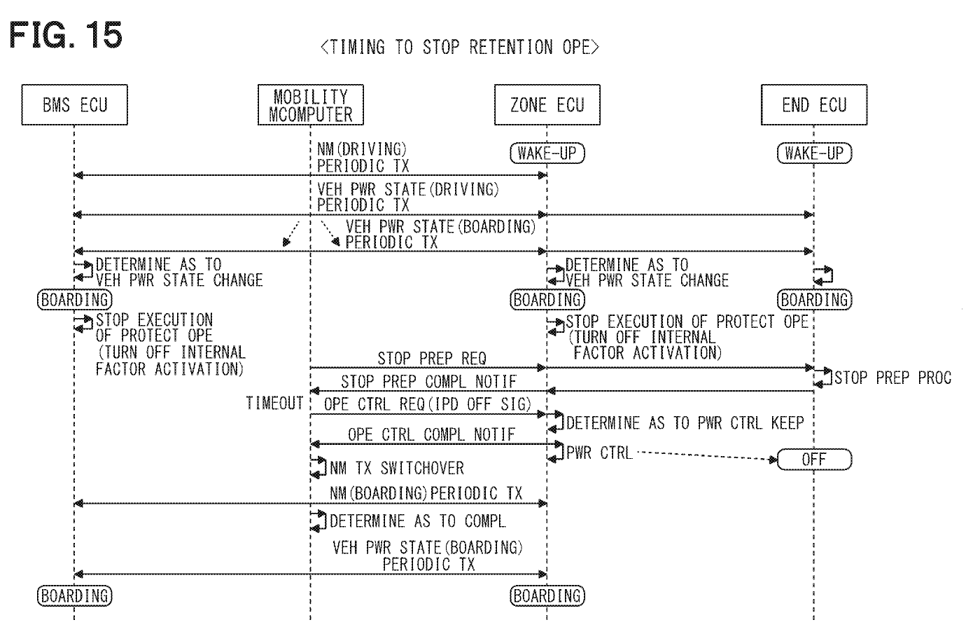

The timing to stop the retention operation by the state retention unit 241, 242 will be described with reference to FIG. 15. Although the description will be given on the mobility computer 2, the first zone ECU 5, the second end ECU 8 and the first BMS 13 by way of example, the same is applicable to others.

In this case, the first zone ECU 5 and the first BMS 13 have the state retention unit 242 as is the case with the ECU 200B. This case also illustrates the transition of the vehicle power state from "driving" to "boarding" by way of example. In FIG. 15, the wake-up state is shown as "WakeUP".

The mobility computer 2 periodically transmits the NM frame for “driving” to the first zone ECU 5 and the BMS 13, and also periodically transmit the vehicle power state information for "driving” to the first zone ECU 5 and the BMS 13. To the second end ECU 8, the first zone ECU 5 periodically transmits the information transmitted from the mobility computer 2. In this situation, when the vehicle power state transitions from "driving" to "boarding", the first zone ECU 5, the first BMS 13 and the second end ECU 8 receive the vehicle power state information indicating "boarding".

The first zone ECU 5, the second end ECU 8 and the first BMS 13 then determines whether or not the vehicle power state information has been changed. In this case, the first zone ECU 5, the second end ECU 8 and the first BMS 13 determine that the vehicle power state information has been changed to "boarding" and updates the self-retaining vehicle power state, which is the retained information indicating the power state of the vehicle as a whole, to "boarding". The state retention units 241 of the first zone ECU 5 and the first BMS 13 stop execution of the retention operation in response to updating the vehicle power state information from “driving” to “boarding”, in other words, in response to changing from a state where the ON trigger is input to a state where the OFF trigger is input.

Next, the mobility computer 2 transmits a stop preparation request for stop preparation of the second end ECU 8 to the first zone ECU 5. The first zone ECU 5 forwards the received stop preparation request to the second end ECU 8. Upon receipt of the stop preparation request, the second end ECU 8 executes a stop preparation process. The stop preparation process may include, for example, storing data into the storage unit 220 in preparation for power cutoff. This data may be data retained by the second end ECU 8 at this point of time.

Upon completion of the stop process, the second end ECU 8 transmits a stop preparation completion notification to the first zone ECU 5. The first zone ECU 5 forwards the received stop preparation completion notification to the mobility computer 2. When a timeout occurs after receiving the stop preparation completion notification, the mobility computer 2 transmits an operation control request for instructing OFF of the IPD 23 to the first zone ECU 5. Upon receipt of the operation control request, the first zone ECU 5 performs a power control keep determination. In the power control keep determination, when the state of the IPD 23, which is ON or OFF, indicated by the operation control request, is not different from the actual controlled state of the IPD 23, the first zone ECU 5 determines to keep the power control. When the state of the IPD 23, which is ON or OFF, indicated by the operation control request, is different from the actual controlled state of the IPD 23, the first zone ECU 5 determines not to keep the power control.

In this example, because the IPD 23 is ON, in the power control keep determination, the first zone ECU 5 determines not to keep the power control. Therefore, the first zone ECU 5 executes the power control based on the received operation control request and turns OFF the IPD 23 to cut off the supply of power to the second end ECU 8. The first zone ECU 5 thereafter transmits an operation control completion notification to the mobility computer 2 indicating that the power control on the second end ECU 8 is complete.

Upon receipt of the operation control completion notification, the mobility computer 2 executes an NM transmission switchover process. Next, the mobility computer 2 periodically transmits the NM frame for “boarding” to the first zone ECU 5 and the first BMS 13. Thereafter, the mobility computer 2 executes a completion determination process and thereafter periodically transmits the vehicle power state information for "boarding" to the first zone ECU 5 and the first BMS 13.

### The above-described embodiment provides the following effect

In the communication system 1 of the present embodiment, at least one of the multiple ECUs includes the state retention unit 241 or 242 that executes the retention operation to retain the wake-up state, wherein the input of the predetermined control information triggers execution of the retention operation. According to this configuration, by the state retention unit 241, 242 executing the retention operation to keep the wake-up state, an occurrence of such an event that the ECU supposed to be in the wake-up state is switched over to the sleep state can be prevented even if the communication frame is cut off due to a communication abnormality or the like. In other words, the present embodiment can prevent the ECU from being wrongly switched over to the sleep mode.

Upon executing the retention operation, the state retention unit 242 transmits, to the outside via the communication line, the communication frame for switching over at least part of: the mobility computer 2 and other ECUs to the wake-up state. In this way, it is possible to prevent the ECU not including the state retention unit 241, 242 from being wrongly switched over to the sleep state.

The communication frame transmitted by the state retention unit 242 may be the communication frame for switching over all the ECUs, including the mobility computer 2 and other ECUs, to the wake-up state. In this way, it is possible to keep all the ECUs, including the mobility computer 2 and other ECUs, at the wake-up state. The communication frame transmitted by the state retention unit 242 may be the communication frame for switching over part of the multiple ECUs to the wake-up state, wherein the multiple ECUs include the mobility computer 2 and other ECUs. In this way, it is possible to separately keep, for example, the zone ECU and the end ECU at the wake-up state.

In the present embodiment, the control information is information represented by the communication signal transmitted via the communication line 31 to 42. Therefore, there may be a possibility that in case of cutoff of the communication via the communication line 31 to 42, the input of the control information may be cut off, which may make it difficult to keep the wake-up state. In view of this, the present embodiment is configured such that when the communication via the communication line 31 to 42 is cut off, the state retention unit 241, 242 determines whether or not to execute the retention operation based on the latest value of the communication signal. In this way, even if the communication via the communication line 31 to 42 is cut off, it is possible to correctly keep the wake-up state.

In the present embodiment, the mobility computer 2 does not include the state retention unit 242. A reason for adopting this configuration is as follows. In a star-type communication topology as in the communication system 1, there may be a possibility that if it becomes impossible to stop execution of the retention operation by the state retention unit 242 and the communication frame transmitted from the state retention unit 242 due to the execution of the retention operation is relayed without restriction, all the ECUs including the ECU supposed to be in the sleep state are kept at the wake-up state.

In the present embodiment, the mobility computer 2 does not include the state retention unit 242, and thus does not relay the communication frame transmitted from the state retention unit 242 of another ECU. In this way, it is possible to keep the wake-up state only for the ECU connected to the ECU including the state retention unit 242 via the communication, and it is possible to prevent that the ECU supposed to be placed in the sleep state via the mobility computer 2 is kept at the wake-up state.

### Modifications on control information

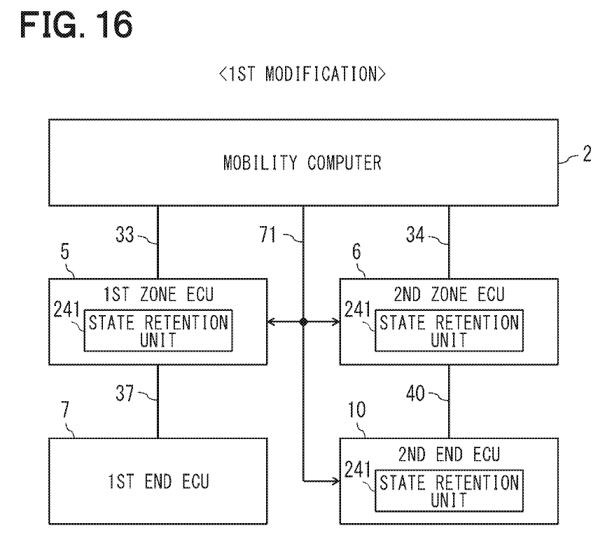

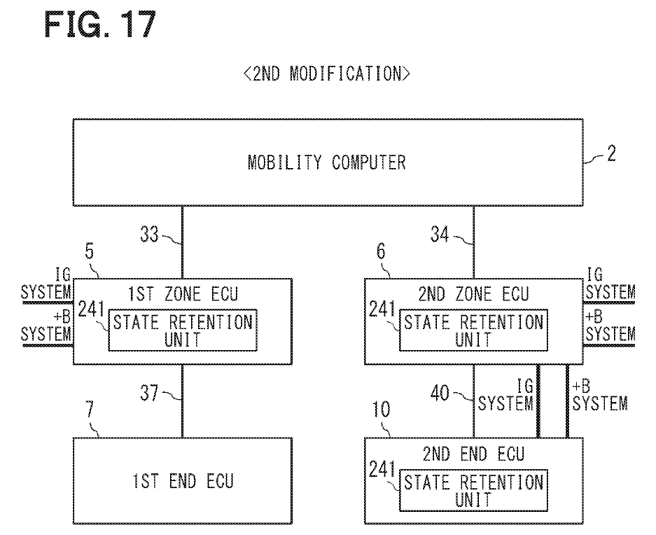

The control information serving as a trigger for the execution of the retention operation is not limited to the information represented by the communication signal transmitted via the communication line 31 to 42. A variety of information is usable as the control information serving as a trigger of the execution of the retention operation. For example, as in the first modification shown in FIG. 16, the control information may be information represented by a control signal transmitted via a signal line 71 separate from the communication line 31 to 42. In FIGS. 16 and 17 described below, ECUs other than the mobility computer 2, the first zone ECU 5, the second zone ECU 6, the first end ECU 7, and the fourth end ECU 10 are not shown. In FIGS. 16 and 17, it is assumed that the first zone ECU 5, the second zone ECU 6, and the fourth end ECU 10 include the state retention unit 241.

In the configuration of the first modification, the signal line 71 is a direct line, such as an interlock line for example. The signal line 71 is connected between the mobility computer 2 and all of the ECUs that include the state retention unit 241 or the state retention unit 242. The control signal transmitted via the signal line 71 is, for example, a binary signal which has a high level when the vehicle power state is "driving”, and which has a low level when the vehicle power state is other than "driving". The high level is a level relatively higher than the low level. In this case, the control signal having the high level functions as the ON trigger and the control signal having the low level functions as the OFF trigger. This configuration of the first modification can also implement the same retention operation as in the present embodiment.

As in the second modification shown in FIG. 17, the control information may be information represented by the state of power supplying. In a configuration of the second modification, at least one of the multiple ECUs is configured such that the power is supplied from one or both of the two systems for power supplying. For example, the first zone ECU 5, the second zone ECU 6 and the fourth end ECU 10 are supplied with the power from one or both of the two systems for power supplying. Also, in this case, the two systems for power supplying are a +B system power supply and an IG system power supply.

In this example, when the vehicle power state is "driving", the first zone ECU 5, the second zone ECU 6, and the fourth end ECU 10 are configured to be supplied with the power from both of the two systems for power supplying. When the vehicle power state is other than "driving", the first zone ECU 5, the second zone ECU 6, and the fourth end ECU 10 are supplied with the power from one of the two systems for power supplying. Further, the first zone ECU 5, the second zone ECU 6 and the fourth end ECU 10 are configured to be able to determine the state of power supplying as to whether or not the power is supplied from the two systems.

Therefore, the first zone ECU 5, the second zone ECU 6, and the fourth end ECU 10 can determine that the ON trigger is input when the state of power supplying is such that the power is supplied from the two systems, and can determine that the OFF trigger is input when the state of power supplying is such that the power is supplied not from the two systems. This configuration of the second modification can also implement the same retention operation as in the present embodiment.

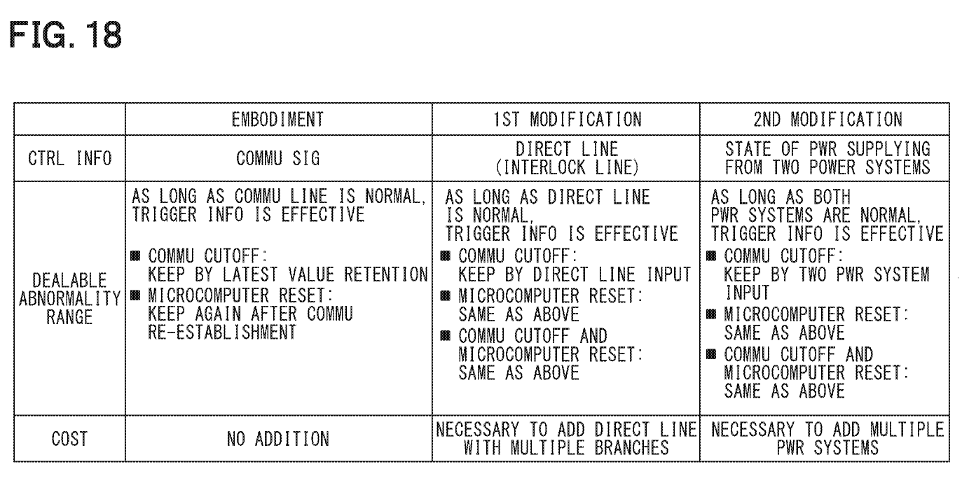

FIG. 18 illustrates the control information and related matters of the present embodiment, the first modification and the second modification, wherein the present embodiment uses the control information represented by the communication signal transmitted via the communication line 31 to 42, the first modification uses the control information represented by the control signal transmitted via the signal line 71, and the second modification uses the control information represented by the state of power supplying.

In the present embodiment, the ON/OFF trigger information is effective as long as the communication line 31 to 42 is normal. Furthermore, in the event of communication cutoff, it is possible to keep the wake-up state by determining whether or not to execute the retention operation based on the latest value of the communication signal. Furthermore, in the event of reset of the microcomputer, it is possible to keep the wake-up state after communication re-establishment. Furthermore, additional hardware is not required for the input of the control information to the state retention unit 241, 242, so that there is no concern about cost increase.

In the first modification, the ON/OFF trigger information is effective as long as the signal line 71 is normal. In the first modification, in the event of communication cutoff and in the event of reset of the microcomputer also, it is possible to keep the wake-up state based on the input from the signal line 71. Furthermore, in the first modification, the signal line 71 having multiple branches may be required for the input of the control information to the state retention unit 241, 242, so that the cost may increase for the signal line 71.

In the second modification, the ON/OFF trigger information is effective as long as the supply of power from the two systems for power supplying is normally performable. In the second modification, in the event of communication cutoff and in the event of reset of the microcomputer also, it is possible to keep the wake-up state based on the state of the supply of power from the two systems for power supplying. Furthermore, in the second modification, the second modification requires the two systems for power supplying with respect to the input of the control information to the state retention units 241 and 242, which may increase the cost.

### Modifications on configuration of communication system

The communication system 1, which includes the multiple ECUs and the management device arranged to be communicable therebetween and which is mounted on a movable object, can be modified in various ways including, for example, the following. In place of the mobility computer 2, a mobility computer with a built-in IPD that has the functions of the mobility computer and the functions of the zone EC may be used. In this case, the mobility computer with the built-in IPD also functions as the management device.

In place of the first and second zone ECUs 5, 6, multiple domain control units may be used. In this case, the domain control units function as multiple ECUs. In this case, the mobility computer 2 may be absent in the communication system, any one of the domain control units may have a master function in an architecture where the multiple domain control units coexist. In such a configuration, the domain control unit having the master function functions as the management device and the other domain control units function as multiple ECUs.

### Other Embodiments

The present disclosure is not limited to the embodiments described above and illustrated in the drawings, and various modifications, combinations and extensions are possible without departing from the spirit and scope of the present disclosure.

The numerical values and the like described in the above embodiments are examples and the present disclosure is not limited to the examples.

While the present disclosure has been described with reference to embodiments thereof, it is to be understood that the disclosure is not limited to the embodiments and constructions. The present disclosure encompasses various examples and modifications within an equivalent range. In addition, various combinations and forms, including a single element, more or less, are also within the sprit and the scope of the present disclosure.

The control units and the methods thereof described in the present disclosure may be implemented by a dedicated computer provided by configuring a processor and a memory programmed to execute one or multiple functions embodied by a computer program. The control units and the methods thereof described in the present disclosure may be implemented by a dedicated computer provided by configuring a processor with one or more dedicated hardware logic circuits. The control units and the methods thereof described in the present disclosure may be implemented by a dedicated computer provided by configuring a processor and a memory programmed to execute one or multiple functions in combination with a processor configured with one or more dedicated hardware logic circuits. The computer program may be stored on a computer-readable non-transitory tangible storage medium as instructions executed by a computer.

What is claimed is:

1. A communication system mounted on a movable object, comprising
a plurality of electronic control units and a management device arranged to be communicable therebetween, wherein:
at least one of the plurality of electronic control units is activated by supply of power from an outside thereof, and is stopped by cutoff of the power from the outside; and
the at least one of the plurality of electronic control units in a state of being supplied with the power is activated by switching over to a wake-up state and is stopped by switching over to a sleep state based on a communication frame received from the outside thereof via a communication line,
the communication system comprising:
a state retention unit that executes a retention operation to retain the wake-up state, wherein input of predetermined control information triggers execution of the retention operation,
wherein the plurality of electronic control units, the management device and the state retention unit are each provided by at least a processor and a memory.

2. The communication system according to claim 1, wherein:
upon executing the retention operation, the state retention unit transmits the communication frame for switching over at least one or more of: the management device and the electronic control units to the wake-up state to an outside thereof via the communication line.

3. The communication system according to claim 1, wherein:
the state retention unit is capable of executing the retention operation even in a case of cutoff of receipt of the communication frame for a wake-up request for a given period of time, wherein the communication frame for the wake-up request is the communication frame for switching over to the wake-up state.

4. The communication system according to claim 1, wherein:
the control information is information represented by a communication signal transmitted via the communication line.

5. The communication system according to claim 1, wherein:
the control information is information represented by a control signal transmitted via a signal line separate from the communication line.

6. The communication system according to claim 1, wherein:
one or more of the plurality of electronic control units is configured to be supplied with the power from one of or both two external systems for power supplying; and
the control information is information represented by a state of the power supplying.

7. The communication system according to claim 2, wherein:
upon executing the retention operation, the state retention unit transmits the communication frame for switching over all of the management device and the electronic control units to the wake-up state to the outside via the communication line.

8. The communication system according to claim 2, wherein:
upon executing the retention operation, the state retention unit transmits the communication frame for switching over part of: the management device and the electronic control unit to the wake-up state to the outside via the communication line.

9. The communication system according to claim 4, wherein:
the state retention unit determines whether or not to execute the retention operation based on a latest value of the communication signal in a case of cutoff of communication via the communication line.

10. The communication system according to claim 1, wherein:
the control information is information that changes according to a state or function of the movable object; and
after executing the retention operation, the state retention unit continues execution of the retention operation if a change in the control information is absent, and stops execution of the retention operation if the change in the control information is present.

11. An electronic control unit in a communication system mounted on a movable object, wherein the communication system includes a plurality of electronic control units and a management device arranged to be communicable therebetween, and the electronic control unit is included in the plurality of electronic control units,
the electronic control unit being configured such that:
the electronic control unit is activated by supply of power from an outside thereof, and stopped by cutoff of the power from the outside;
the electronic control unit in a state of being supplied with the power is activated by switching over to a wake-up state and is stopped by switching over to a sleep state based on a communication frame received from the outside thereof via a communication line; and
the electronic control unit executes a retention operation to retain the wake-up state, wherein input of predetermined control information triggers execution of the retention operation,
wherein the plurality of electronic control units and the management device are each provided by at least a processor and a memory.

12. A wake-up retention program stored on a non-transitory storage medium for an electronic control unit in a communication system mounted on a movable object, wherein the communication system includes a plurality of electronic control units and a management device arranged to be communicable therebetween, and the electronic control unit is included in the plurality of electronic control units,
the wake-up retention program causing the electronic control unit to perform:
activating by supply of power from an outside thereof and stopping by cutoff of the power from the outside;
in a state of being supplied with the power, activating by switching over to a wake-up state and stopping by switching over to a sleep state based on a communication frame received from the outside thereof via a communication line; and
executing a retention operation to retain the wake-up state, wherein input of predetermined control information triggers execution of the retention operation,
wherein the plurality of electronic control units and the management device are each provided by at least a processor and a memory.

13. A wake-up retention method executed by an electronic control unit in a communication system mounted on a movable object, wherein the communication system includes a plurality of electronic control units and a management device arranged to be communicable therebetween, and the electronic control unit is included in the plurality of electronic control units, the management device is provided by a least a processor and a memory,
the wake-up retention method comprising:
the electronic control unit activating by supply of power from an outside thereof and stopping by cutoff of the power from the outside;
the electronic control unit in a state of being supplied with the power activating by switching over to a wake-up state and stopping by switching over to a sleep state based on a communication frame received from the outside thereof via a communication line; and
the electronic control unit executing a retention operation to retain the wake-up state, wherein input of predetermined control information triggers execution of the retention operation,
wherein the plurality of electronic control units and the management device are each provided by at least a processor and a memory.
